(19) United States
(12) Patent Application Publication
(10) Pub. No.: US 2025/0348487 A1
(43) Pub. Date: Nov. 13, 2025

(54) QUERY TTL PENALTY BOX IN AUTO

(71) Applicant: CAST AI Group, Inc., Miami, FL (US)

(72) Inventors: Benjamin Sean Gray, Reading (GB); Luka Androjna, Ljubljana (SI); Ben Hagan, Buckinghamshire (GB); Matt Calder, Framingham, MA (US)

(73) Assignee: CAST AI Group, Inc., Miami, FL (US)

(21) Appl. No.: 18/919,316

(22) Filed: Oct. 17, 2024

Related U.S. Application Data
(60) Provisional application No. 63/644,553, filed on May 9, 2024.
(60) Provisional application No. 63/649,048, filed on May 17, 2024.
(60) Provisional application No. 63/649,024, filed on May 17, 2024.

(51) Int. Cl. G06F 16/2453

(52) U.S. Cl. CPC G06F 16/24539

(57) ABSTRACT

A method for managing time-to-live (TTL) associated with a query stored in a cache, the method comprising a processor performing the following operations in an iteratively manner: detecting a first cache miss and a second cache miss associated with the query; detecting a difference between a first payload associated with the first cache miss and a second payload associated with the second cache miss; and for the difference not being detected, initializing the TTL of the query to a first time period.

### CROSS-REFERENCE TO RELATED APPLICATIONS

This application claims priority under 35 USC § 119(e) to U.S. Provisional Application Nos. 63/649,048, filed on May 17, 2024, 63/644,553, filed on May 9, 2024, and 63/649,024, filed on May 17, 2024, the contents of which are incorporated herein by reference in their entirety.

### BACKGROUND

### Field

The present disclosure is generally directed to a method and a system for performing time-to-life (TTL) management associated with a query and query result/data stored in a cache.

### Related Art

In typical query traffic, most of the queries are observed only once and require direct access to the database to perform data operations associated with the queries (e.g. parsing, retrieving data, etc.). A query cache complements the database by storing data that are frequently-queried to relieve the computational pressure/burden on the database. Since most queries are observed only once, it is therefore not possible to derive any caching benefit for such queries. At the time a query is first seen, it is useful to determine the likelihood that that query will never be seen again and act accordingly. Once a query entry is determined not to be a “one-hit wonder” (e.g. surpassing an access frequency threshold within a period of time, etc.), the query entry and associated results as retrieved from the database can then be cached.

For a cached query entry, the Time-to-live (TTL) is the amount of time that the cached query entry can be served from the cache after it has been cached/stored. On expiration of the TTL, the cached data entry may be removed/retired from the cache. However, it is difficult to determine just what value to set a query's TTL to in order to optimize cache-stay.

### SUMMARY

In an embodiment, a method for managing time-to-live (TTL) associated with a query stored in a cache comprises: detecting a first cache miss and a second cache miss associated with the query; detecting a difference between a first payload associated with the first cache miss and a second payload associated with the second cache miss; for the difference not being detected, initializing the TTL of the query to a first time period.

The cache may be a wire protocol-compatible database cache configured to communicate between an application that receives a user input including the query and a database associated with the first payload and the second payload.

The method may further comprise, for the difference being detected, removing a query result associated with the query from the cache and placing the query in a penalty state in which the TTL is not further increased or reduced

The method may further comprise, for the query in the penalty state, once a condition is satisfied: caching a current query result associated with the query into the cache and removing the query from the penalty state.

The condition may comprise: while the query is in the penalty state, incrementing a counter each time the query is received from an application; and comparing the counter against a query threshold indicative of a threshold number of queries received from the application while the TTL is in the penalty state.

The method may further comprise: determining whether the counter is equal to the query threshold; and for the counter determined to be equal to the query threshold, removing the query from the penalty state.

In an embodiment, a method for adjusting time-to-live (TTL) associated with a query stored in a cache comprises: detecting a first cache miss and a second cache miss associated with the query; detecting a difference between a first payload associated with the first cache miss and a second payload associated with the second cache miss; for the difference not being detected, increasing the TTL of the query by a first amount of time; and for the difference being detected, reducing the TTL of the query by a second amount of time.

The method may further comprise, for the TTL being reduced to equal to or less than a TTL threshold, preventing a query result associated with the query from being stored in the cache

The first amount of time may be set to 20% of the TTL, and the second amount of time may be set to 40% of the TTL. The TTL threshold may be set to 50 milliseconds.

In an embodiment, a system for managing time-to-live (TTL) associated with a query comprises: a cache for storing the query; and a processor in communication with the cache and iteratively performs: detect a first cache miss and a second cache miss associated with the query; detect a difference between a first payload associated with the first cache miss and a second payload associated with the second cache miss; and for the difference not being detected, initialize the TTL of the query to a first time period.

The cache may be a wire protocol-compatible database cache configured to communicate between an application that receives a user input including the query and a database associated with the first payload and the second payload.

The processor of the system may be further configured to, for the difference being detected, remove a query result associated with the query from the cache and place the query in a penalty state in which the TTL is not further increased or reduced. The processor of the system may be further configured to, for the query in the penalty state, once a condition is satisfied: cache a current query result associated with the query into the cache and remove the query from the penalty state.

The condition may comprise: while the query is in the penalty state, incrementing a counter each time the query is received from an application; and comparing the counter against a query threshold indicative of a threshold number of queries received from the application while the TTL is in the penalty state.

The processor of the system may be further configured to determine whether the counter is equal to the query threshold; and for the counter determined to be equal to the query threshold, remove the query from the penalty state.

In an embodiment, a non-transitory computer readable medium storing computer executable code for managing time-to-live (TTL) associated with a query stored in a cache, the code when executed by a processor causes the processor to: detect a first cache miss and a second cache miss associated with the query; detect a difference between a first payload associated with the first cache miss and a second payload associated with the second cache miss; and for the difference not being detected, initialize the TTL of the query to a first time period.

The cache may be a wire protocol-compatible database cache configured to communicate between an application that receives a user input including the query and a database associated with the first payload and the second payload.

The processor may be further configured to, for the difference being detected, remove a query result associated with the query from the cache and place the query in a penalty state in which the TTL is not further increased or reduced. The processor of the system may be further configured to, for the query in the penalty state, once a condition is satisfied: cache a current query result associated with the query into the cache and remove the query from the penalty state.

The condition may comprise: while the query is in the penalty state, incrementing a counter each time the query is received from an application; and comparing the counter against a query threshold indicative of a threshold number of queries received from the application while the TTL is in the penalty state.

The processor may be further configured to determine whether the counter is equal to the query threshold; and for the counter determined to be equal to the query threshold, remove the query from the penalty state.

In an embodiment, a non-transitory computer readable medium storing instructions for managing time-to-live (TTL) associated with a query stored in a cache comprises: performing the following operations in an iterative manner: detecting a first cache miss and a second cache miss associated with the query; detecting a difference between a first payload associated with the first cache miss and a second payload associated with the second cache miss; for the difference not being detected, initializing the TTL of the query to a first time period.

The cache may be a wire protocol-compatible database cache configured to communicate between an application that receives a user input including the query and a database associated with the first payload and the second payload.

The non-transitory computer readable medium may further comprise, for the difference being detected, removing a query result associated with the query from the cache and placing the query in a penalty state in which the TTL is not further increased or reduced

The non-transitory computer readable medium may further comprise, for the query in the penalty state, once a condition is satisfied: caching a current query result associated with the query into the cache and removing the query from the penalty state.

The condition may comprise: while the query is in the penalty state, incrementing a counter each time the query is received from an application; and comparing the counter against a query threshold indicative of a threshold number of queries received from the application while the TTL is in the penalty state.

The non-transitory computer readable medium may further comprise: determining whether the counter is equal to the query threshold; and for the counter determined to be equal to the query threshold, removing the query from the penalty state.

### BRIEF DESCRIPTION OF DRAWINGS

A general architecture that implements the various features of the disclosure will now be described with reference to the drawings. The drawings and the associated descriptions are provided to illustrate example embodiments of the disclosure and not to limit the scope of the disclosure. Throughout the drawings, reference numbers are reused to indicate correspondence between referenced elements.

FIG. 1 illustrates an example query time-to-live (TTL) management system 100 in accordance with some embodiments described herein.

FIG. 2 illustrates an example timeline diagram 200 in accordance with some embodiments described herein.

FIG. 3 illustrates an example process flow 300 for managing TTL associated with a query entry in accordance with some embodiments described herein.

FIG. 4 illustrates an alternative penalty box/state setting process flow 400 in accordance with some embodiments described herein.

FIG. 5 illustrates an example TTL adjustment process flow 500 in accordance with some embodiments described herein.

FIG. 6 illustrates an example computing environment with an example computer device suitable for use in some example embodiments.

### DETAILED DESCRIPTION

The following detailed description provides details of the figures and example embodiments of the present application. Reference numerals and descriptions of redundant elements between figures are omitted for clarity. Terms used throughout the description are provided as examples and are not intended to be limiting. For example, the use of the term “automatic” may involve fully automatic or semi-automatic embodiments involving user or administrator control over certain aspects of the embodiment, depending on the desired embodiment of one of the ordinary skills in the art practicing embodiments of the present application. Selection can be conducted by a user through a user interface or other input means, or can be implemented through a desired algorithm. Example embodiments as described herein can be utilized either singularly or in combination and the functionality of the example embodiments can be implemented through any means according to the desired embodiments.

Example embodiments provide a new system and method for managing TTL of cached query entries. During query processing, the TTL is automatically and dynamically adjusted for cached entries (e.g. increasing or decreasing the TTL depending on the specific pattern of the query's arrival and change). A cached query is placed in a penalty state (“penalty box”) when the payload has changed unexpectedly after the query's TTL ran out. The TTL adjustment process is triggered based on the comparison of the payloads before and after invalidation.

Error detection is an imperfect process, since it is difficult to know when stale data has been served. This is due to the fact that the state of results as stored in the database is unknown when a hit is served from the cache. Given the dynamic nature of TTL estimation, and the uncertainty of observation, it is important to consider the question of when to put the query into or out of the penalty box, which is described in more detail below.

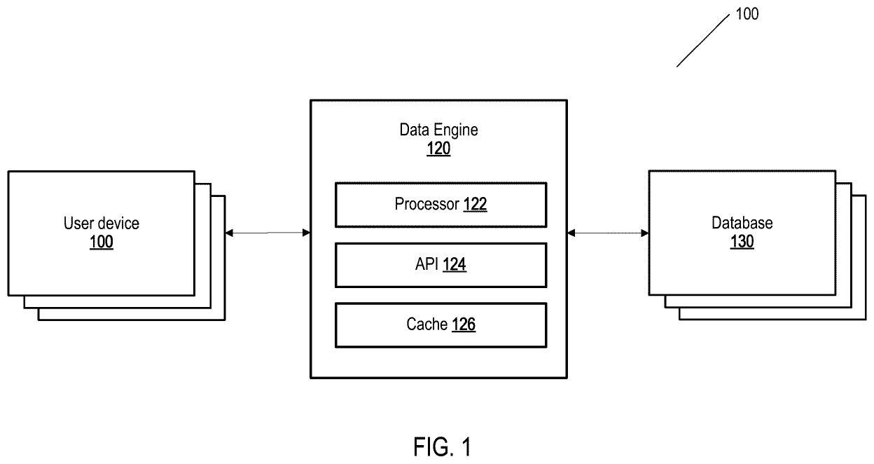

FIG. 1 illustrates an example query time-to-live (TTL) management system 100 in accordance with some embodiments described herein. As illustrated in FIG. 1, the query TTL management system 100 may include components such as, but not limited to, one or more user devices 110, a data engine 120, a database 130, etc. The one or more user devices 110 communicates with the data engine 120 and the database 130 via one or more networks. In particular, the one or more user devices may issue application programming interface (API) calls requesting data operations to the data engine 120 and the database 130 via one or more networks to access stored data or triggering other data functions/operations. The one or more networks may comprise internet, local area network (LAN), wide area network (WAN), telephonic network, cellular network, satellite network, etc.

User(s) of the one or more user devices 110 may specify the information that is needed through one or more applications operating on the user devices 110. In turn, application API calls are then issued through the applications from the user devices 110 to destinations such as the data engine 120 and the database 130. Examples of the one or more user devices 110 may include, but not limited to mobile devices (e.g. smartphones, devices in vehicle and other machine, tablets, notebooks, laptops, personal computers, etc.), and devices not designed for mobility (e.g. desktop computers, information kiosks, televisions, etc.) that are capable of wired or wireless communication.

The data engine 120 is a proxy service that facilitates performance of data operations between the one or more user devices 110 and the database 130. For example, receiving an SQL query from a user device 110 and communicating the query for a data operation to be performed by the database 130 (e.g. data retrieval). The data engine 120 may be implemented on a platform comprising one or more servers, and may include components such as, but not limited to, a processor 122, an application programming interface (API) 124, one or more caches 126, etc.

The API 124 receives requests/calls (queries) from the one or more user devices 110 (e.g. through applications executed on the one or more user devices 110) for performing data operations such as, but not limited to, data storing and retrieval in association with the data engine 120 and the database 130. The one or more caches 126 are wire protocol-compatible database caches that ensure effective communication/interoperability between the one or more user devices 110 and the database 130.

In some embodiments, the one or more caches 126 are memory caches for storing/caching queries and query results generated by the database 130 for future retrieval. Only queries that have been determined to be frequently accessed are stored/cached in the one or more caches 126. In response to receiving an API call for a data operation (query) from the one or more user devices 110 at the API 124, the processor 122 first checks the one or more caches 126 to determine whether the same query and results associated with the query have already been cached. If the processor 122 determines that the results of the data operation are cached in the one or more caches 126, then the processor 122 retrieves the results from the one or more caches 126 without needing to access the database 130 to perform query parsing and retrieve such results. By so doing, response time is significantly improved while computational resources wasted through parsing and data manipulation/processing of the same queries can be reduced.

Communications between the one or more user devices 110, the data engine 120, and the database 130 are facilitated via one or more networks. The one or more networks may comprise internet, local area network (LAN), wide area network (WAN), telephonic network, cellular network, satellite network, etc., utilizing any transmission protocols such as, but not limited to, Hypertext Transfer Protocol (HTTP), HTTP Secure (HTTPS), Transmission Control Protocol (TCP), File Transfer Protocol (FTP), FTP Secure (FTPS), SSH FTP (SFTP), Trivial File Transfer Protocol (TFTP), etc.

### Type-1 Error and TTL Estimation

A type-1 error occurs when stale data is returned to the client as a cache hit. As an example, this may occur when two subsequent cache misses, with cache hits served between those cache misses, return different results from the database with no occurrence of invalidation event.

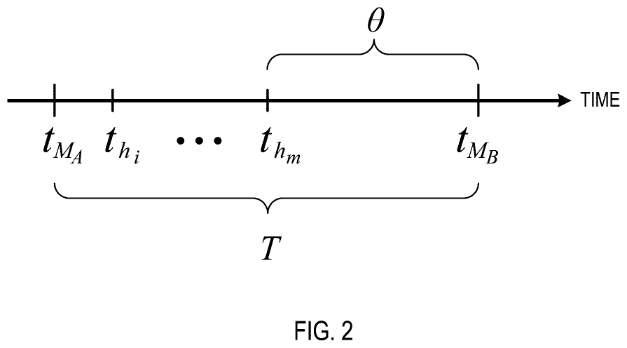

FIG. 2 illustrates an example timeline diagram 200 in accordance with some embodiments described herein. As illustrated in FIG. 2, the first cache miss is represented by M_{A} and the second cache miss is represented by M_{B}. For each miss that occurs, the database 130 is accessed to retrieve the results associated with the input query, and a determination is made to see whether results for M_{A} differ from the results for M_{B}.

As illustrated in FIG. 2, cache hits served between the two misses are represented by h₁. . . hₘ, and it is assumed that no invalidation event has occurred during that time. If an invalidation event had occurred, which is treated as the reason for the change, then it is possible for the payloads from the database for the two misses to be different.

The sequence of events thus becomes

M_{A}, h₁, . . . , hₘ, M_{B}

In order to analyze the probability of error, it is assumed that the queries arrive as a Poisson process and that the database state changes as a Poisson process with a change rate Δ.

The change rate Δ, the time between misses T=t_{M}_{_{B}}-t_{M}_{_{A}}, and the time between the last hit and the second miss θ=t_{M}_{_{R}}-tₕ_{ₘ} are taken into consideration in estimating the probability of at least one error occurrence. The probability of at least one error occurrence can be calculated by conditioning on the number of change events and is represented by:

$$P ( Any error ) = {\sum }_{k = 1}^{∞} P ( k changes \vert At least one ) P ( A change before last hit \vert k changes ) = {\sum }_{k = 1}^{∞} \frac{{( \frac{T}{Δ} )}^{k} {e}^{- \frac{T}{Δ}}}{k ! ( 1 - {e}^{\frac{T}{Δ}} )} ( 1 - {( \frac{θ}{Δ} )}^{k} ) = \frac{1 - {e}^{- \frac{T - θ}{Δ}}}{1 - {e}^{- \frac{T}{Δ}}}$$

Since there was at least one known change (e.g. the difference between payloads), the probability of & changes can be derived by performing normalization of Poisson distribution normalization to remove changes that are zero. In addition, given that occurrences of the & Poisson events are uniformly distributed in an interval, a summation can be performed using a Poisson probability density function (PDF).

The probability of an error can be represented as the ratio of the relative time periods scaled by Δ. Consider the case where Δ=T=1, then the probability of error varies from 1 (when θ=0, with hits all occurring at the same time as the first miss) to 0 (when θ=1, where the last hit occurs at the same time as the second miss).

However, example embodiment instead uses a more complicated measurement, the expected number of errors in the interval. Assuming there were k database changes in the time interval [0, T], the probability that the first change occurred between the time h and h+∈ hit is given by the equation:

$${P}_{h , h + ∈} = P ( c ∈ ( h , h + ∈ ) \vert k changes ) = {( 1 - \frac{h}{T} )}^{k} - {( 1 - \frac{h + ∈}{T} )}^{k} \\ where 0 < h < h + ∈ < T$$

As a consequence of the uniform distribution of Poisson process event, the following can be derived

$$P ( c ∈ ( h , h + ∈ ) \vert a t least 1 change ) = {\sum }_{k = 1}^{∞} P ( k changes ) P ( c ∈ ( h , h + ∈ ) \vert k changes ) = {\sum }_{k = 1}^{∞} \frac{{( \frac{T}{Δ} )}^{k} {e}^{- \frac{T}{Δ}}}{k ! ( 1 - {e}^{\frac{T}{Δ}} )} ( ( 1 - {( \frac{h}{T} )}^{k} ) - ( 1 - {( \frac{h + ∈}{T} )}^{k} ) ) = \frac{{e}^{- \frac{h + e}{Δ} - {e}^{- \frac{h}{Δ}}}}{1 - {e}^{- \frac{T}{Δ}}}$$

The equation can be used to calculate the probability that the first change occurs in an interval where there is at least one change, and can be represented as

$${p}_{h , h + ∈} = P ( c ∈ ( h , h + ∈ ) \vert at least 1 change )$$

Given that the hits are also the result of a Poisson process (the query arrival process) and since there are m hits, by assuming that the times of the hits are uniform, the following can be derived

$${h}_{i} = {h}_{1} + \frac{( i - 1 ) δ}{k - 1} i = 1 … k$$

where δ=hₖ-h₁, which is the time between the first hit and the last hit. Since only the time of the first hit, the time of the last hit, and the count of the number of hits are stored, this reduces the amount of information/data needing to be stored and processed for computation.

By denoting the probability that the first database change occurs in the time interval (t₁, t₂) as pₜ_{_{1,}} ₜ_{₂} then, the expected number of errors in the interval (0, T) becomes

$$E \{ \# of errors \} = m {p}_{0 , {h}_{1}} + ( m - 1 ) {p}_{{h}_{1} , {h}_{2}} + … + {p}_{{h}_{m - 1} , {h}_{m}} = \frac{1}{1 - {e}^{\frac{T}{Δ}}} ( m - {e}^{\frac{- {h}_{1}}{Δ}} ( \frac{1 - {e}^{\frac{- δ}{Δ} m}}{1 - {e}^{\frac{- δ}{Δ}}} ) )$$

The expected number of errors is m times the probability that the first change occurs before the first hit, plus m-1 times the probability the first change is between the first hit and second hit, and so on. When a possible type-1 error is detected, the expected number of errors is computed and this value dictates how long the query stays in the penalty box/penalty state for. Application of the expected number of errors in the penalty box/penalty state will be described in more detail below.

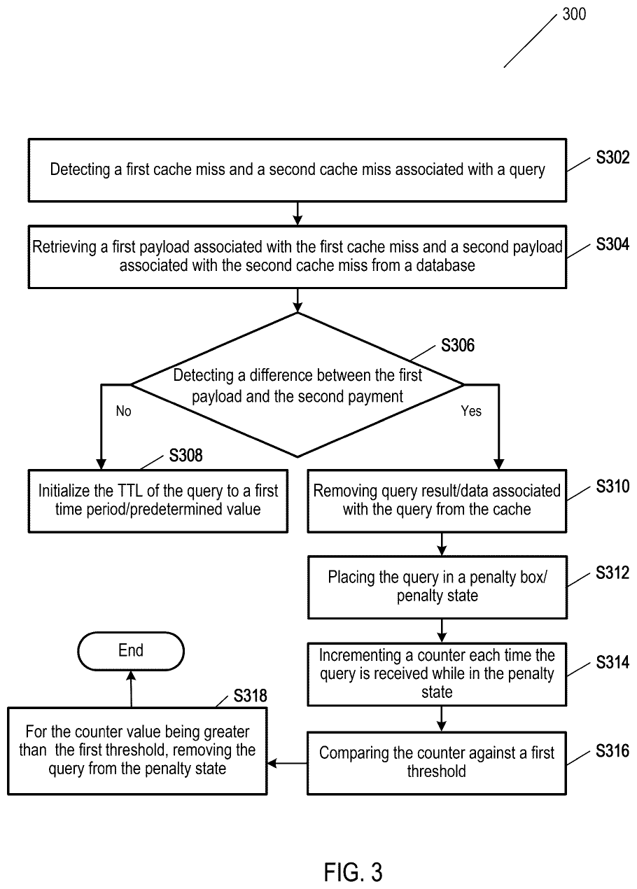

FIG. 3 illustrates an example process flow 300 for managing TTL associated with a query entry in accordance with some embodiments described herein. The process begins at step S302 where a first cache miss event and a second cache miss event associated with a query entry stored in a query cache are detected. At step S304, a first payload associated with the first cache miss event and a second payload associated with the second cache miss event are retrieved from the database. After which, detection of a difference between the first payload and the second payload is performed at step S306.

If a difference is not detected at step S306, then the TTL of the query entry is initialized to a predetermined value at step S308. On the other hand, if a difference is detected at step S306, then the process continues to step S310 where the data/query result associated with the query entry is removed from the query cache.

On completion of step S310, the process then continues to step S312 where the query entry is placed in a penalty box/a penalty state in which the TTL is not further incremented or reduced. At step S314, while the query is in the penalty state, a counter in initialized and incremented each time the query is received by the data engine 120 from a user device 110. At step S316, the counter is compared against a first threshold (e.g. an integer, a float, etc.) indicative of a threshold number of queries received from the application while the query is in the penalty state. The second threshold corresponds to the expected number of errors when a possible type-1 error is detected.

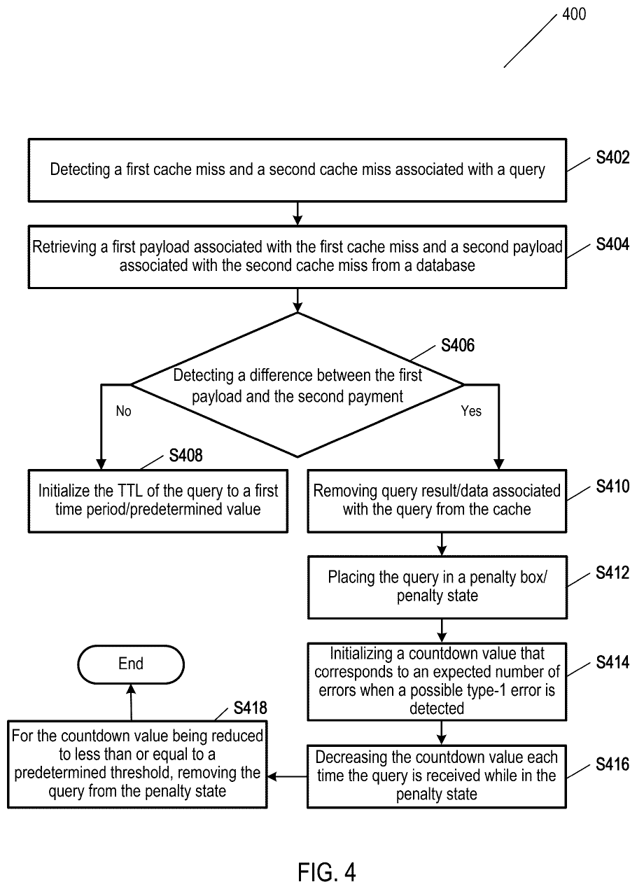

At step S318, for the counter being determined as greater than or equal to the first threshold (“worked off”), removing the query from the penalty state and start caching current query result/data into the query cache. Query storing/recaching may involve query result/data storing, partial query storing, line-by-line storing, partial query result/data storing, etc. The first threshold can be an integer or a float. For example, if the first threshold is determined to be an integer with the value of “21”, then the query is release from the penalty state when the counter value is greater than “21”. Steps S302-318 are performed in an iterative manner to continuously observing/monitoring the query. In some embodiments, instead of initializing a counter for incrementation at step S314, a countdown value (e.g. an integer, a float, etc.) is initialized and corresponds to the expected number of errors when a possible type-1 error is detected. FIG. 4 illustrates an alternative penalty box/state setting process flow 400 in accordance with some embodiments described herein. As illustrated in FIG. 4, steps S402-412 correspond to steps S302-312 of FIG. 3.

At step S414, while the query is in the penalty state, initializing a countdown value that corresponds to the expected number of errors when a possible type-1 error is detected. The process then continues to step S416 where the countdown value in decreased each time the query is received from an application while the query is in the penalty state. At step S418, for the countdown value being reduced to a predetermined threshold (e.g. zero, etc.), removing the TTL from the penalty state and start caching current query result/data into the query cache. Query storing/recaching may involve query result/data storing, partial query storing, line-by-line storing, partial query result/data storing, etc.

The countdown value reduced by one each time the query entry is received from a user device while the penalty state is active. If the countdown value is reduced to or below a predetermined value (e.g. below one for float, one or zero for integer, etc.), then the query is released from the penalty state. Using integer as an example, if the countdown value is determined to be “21”, then the query is released from the penalty state when 21 instances of query entry were observed while query is in the penalty state. Steps S402-418 are performed in an iterative manner to continuously observing/monitoring the query.

### Automated TTL Adjustment

In the related art, a cached data entry may be removed/retired from the cache once the TTL expires. However, it is difficult to determine just what value to set a query's TTL to in order to optimize cache-stay. Example embodiments provide a new system and method for managing/adjusting TTL of cached query entries and associated data/query results. By dynamic adjusting the TTL, this ensures that cached query entries are neither retired too early or too late (e.g. stale), which in turn improves overall memory performance while retaining data correctness at the same time.

In action, if two subsequent misses are observed and the payload (results as retrieved from the database 130) does not change, then the TTL is increased by a first amount of the TTL (e.g., 20%, etc.). Specifically, if the cached query is invalidated before the payload changes, the TTL is increased by 20%.

On the other hand, if two subsequent misses are observed and payload did change (indicating changes to the results stored on the database), then the TTL is decreased by a second amount of the TTL (e.g., 40%, etc.). For example, if an invalidation event occurs before the cached query is invalidated, the TTL is reduced by 40%. In some embodiments, the first amount is less than the second amount. In alternate embodiments, the first amount can be the same as the second amount (e.g., 30% for both).

Once the TTL is reduced to being less than or equal to the minimum TTL threshold, the query result/data is determined to be changing so fast that it is not worth caching the query in the cache 126.

In some embodiments, these geometric increments and decrements occur iteratively between two bounds/thresholds, a maximum TTL threshold and a minimum TTL threshold. The TTL is only allowed to be incremented to as high as the maximum TTL threshold. In some embodiments, only a minimum TTL threshold is required, and the maximum TTL is dispensed. In some embodiments, the minimum TTL threshold is set to a predetermined value (e.g. 50 milliseconds, etc.). In other embodiments, the minimum TTL threshold is derived from an Artificial Intelligence (AI)/Machine Learning (ML) model executed by the processor 122 that has been trained using historical minimum TTL thresholds. The AI/ML model may include, but not limited to, convolutional neural network (CNN), recurrent neural network (RNN), deep RNN (DRNN), Q-learning network (QN), deep Q-learning network (DQN), linear regression, decision trees, K-Nearest Neighbors, etc. RNN may include long short-term memory (LSTM), large language model (LLM), etc.

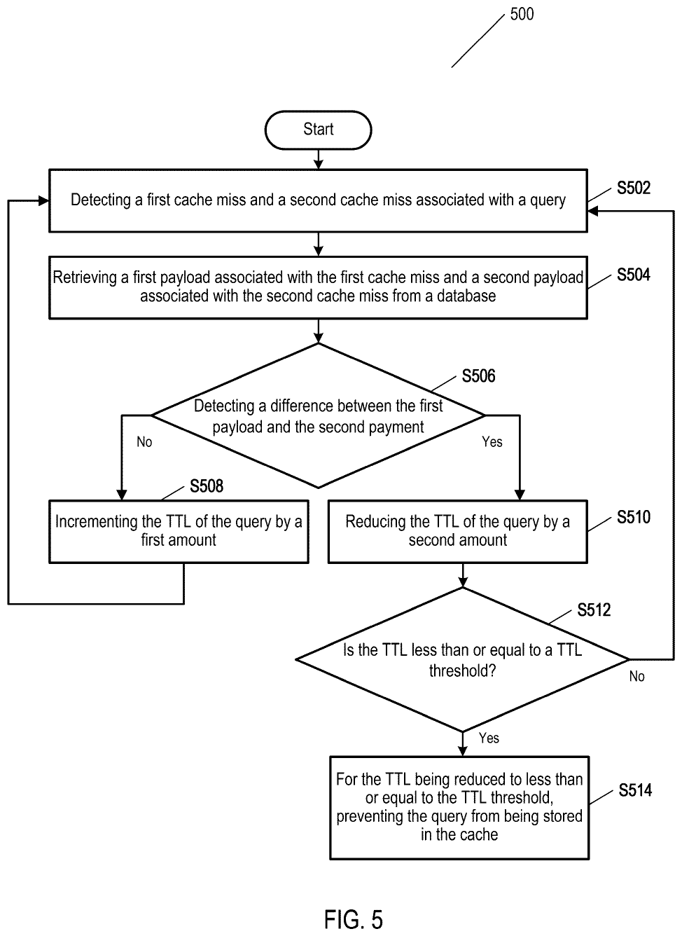

FIG. 5 illustrates an example TTL adjustment process flow 500 in accordance with some embodiments described herein. At step S502, a first cache miss event and a second cache miss event associated with a query entry stored in a query cache are detected. At step S504, a first payload associated with the first cache miss event and a second payload associated with the second cache miss event are retrieved from the database. After which, detection of a difference between the first payload and the second payload is performed at step S306.

If a difference is not detected at step S506, then the TTL of the query entry is increased by a first amount of time at step S508. In some embodiments, the first amount of time is 20% of the present TTL. On completion of TTL incrementation, then process then returns to step S502. On the other hand, if a difference is detected at step S506, then the process continues to step S510 where the TTL of the query entry is reduced by a second amount of time. In some embodiments, the second amount of time is 40% of the present TTL.

On completion of step S510, a determination is made as to whether the current TTL is less than or equal to a minimum TTL threshold after the TTL has been reduced at step S512. For the TTL being reduced to less than the minimum TTL threshold (e.g. 50 milliseconds), the query entry is prevented from being stored in the query cache at step S514. Otherwise, the process returns to step S502. Steps S502-514 are performed in an iterative manner to continuously incrementing or reducing the TTL.

The foregoing example implementations may have various benefits and advantages. For example, by optimizing the TTL of caches query entries, overall retrieval time and computational resources can be reduced significantly. Dynamic adjustment of the TTL ensures that cached query entries are neither retired too early or too late (e.g. stale), which in turn improves memory performance while retaining data correctness.

The foregoing example implementations may have various benefits and advantages. For example, by optimizing the TTL of cached query entries, overall retrieval time and computational resources can be reduced significantly. Dynamic adjustment of the TTL ensures that cached query entries are neither retired too early or too late (e.g. stale), which in turn improves memory performance while retaining data correctness.

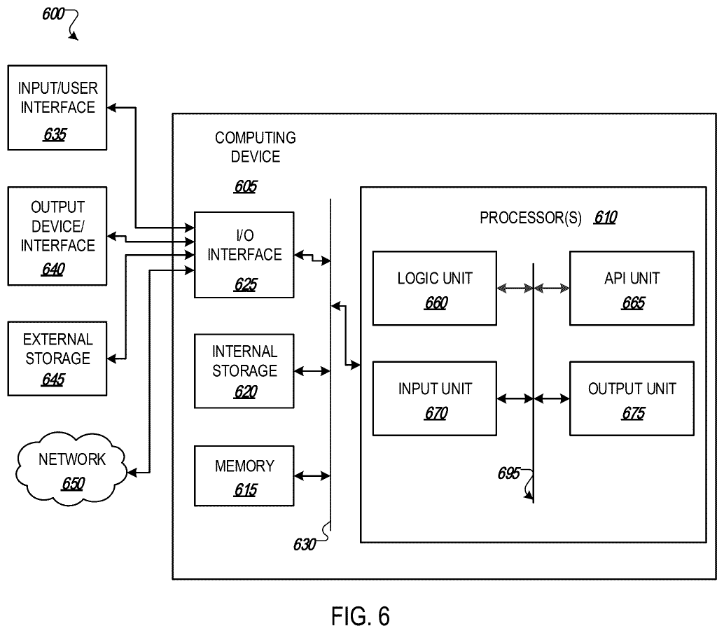

FIG. 6 illustrates an example computing environment with an example computer device suitable for use in some example embodiments. Computer device 605 in computing environment 600 can include one or more processing units, cores, or processors 610, memory 615 (e.g., RAM, ROM, and/or the like), internal storage 620 (e.g., magnetic, optical, solid-state storage, and/or organic), and/or IO interface 625, any of which can be coupled on a communication mechanism or bus 630 for communicating information or embedded in the Computer device 605. IO interface 625 is also configured to receive images from cameras or provide images to projectors or displays, depending on the desired embodiment.

Computer device 605 can be communicatively coupled to input/user interface 635 and output device/interface 50640. Either one or both of the input/user interface 635 and output device/interface 50640 can be a wired or wireless interface and can be detachable. Input/user interface 635 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 50640 may include a display, television, monitor, printer, speaker, braille, or the like. In some example embodiments, input/user interface 635 and output device/interface 50640 can be embedded with or physically coupled to the Computer device 605. In other example embodiments, other computer devices may function as or provide the functions of input/user interface 635 and output device/interface 50640 for a Computer device 605.

Examples of Computer device 605 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 605 can be communicatively coupled (e.g., via IO interface 625) to external storage 645 and network 650 for communicating with any number of networked components, devices, and systems, including one or more computer devices of the same or different configuration. Computer device 605 or any connected computer device can be functioning as, providing services of, or referred to as a server, client, thin server, general machine, special-purpose machine, or another label.

IO interface 625 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 600. Network 650 can be any network or combination of networks (e.g., the Internet, local area network, wide area network, a telephonic network, a cellular network, satellite network, and the like).

Computer device 605 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 605 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 610 can execute under any operating system (OS) (not shown), in a native or virtual environment. One or more applications can be deployed that include logic unit 660, application programming interface (API) unit 665, input unit 670, output unit 675, and inter-unit communication mechanism 695 for the different units to communicate with each other, with the OS, and with other applications (not shown). The described units and elements can be varied in design, function, configuration, or embodiment and are not limited to the descriptions provided. Processor(s) 610 can be in the form of hardware processors such as central processing units (CPUs) or in a combination of hardware and software units.

In some example embodiments, when information or an execution instruction is received by API unit 665, it may be communicated to one or more other units (e.g., logic unit 660, input unit 670, output unit 675). In some instances, logic unit 660 may be configured to control the information flow among the units and direct the services provided by API unit 665, the input unit 670, the output unit 675, in some example embodiments described above. For example, the flow of one or more processes or embodiments may be controlled by logic unit 660 alone or in conjunction with API unit 665. The input unit 670 may be configured to obtain input for the calculations described in the example embodiments, and the output unit 675 may be configured to provide an output based on the calculations described in example embodiments.

Processor(s) 610 can be configured to detect a first cache miss and a second cache miss associated with a query as illustrated in FIG. 1 and FIG. 3. The processor(s) 610 may also be configured to detect a difference between a first payload associated with the first cache miss and a second payload associated with the second cache miss as illustrated in FIG. 1 and FIG. 3. The processor(s) 610 may also be configured to, for the difference not being detected, initialize the TTL of the query to a first time period as illustrated in FIG. 1 and FIG. 3.

The processor(s) 610 may also be configured to, for the reduced TTL being less than or equal to a first threshold, remove a query result associated with the query from the cache and placing the query in a penalty state in which the TTL is not further increased or reduced as illustrated in FIG. 1 and FIG. 3. The processor(s) 610 may also be configured to, for the query in the penalty state, once a condition is satisfied: cache a current query result associated with the query into the cache and remove the query from the penalty state as illustrated in FIG. 1 and FIG. 3.

The processor(s) 610 may also be configured to determine whether the counter is equal to the query threshold; and for the counter determined to be equal to the query threshold, remove the query from the penalty state as illustrated in FIG. 1 and FIG. 3.

The processor(s) 610 may also be configured to detect a first cache miss and a second cache miss associated with the query as illustrated in FIG. 5. The processor(s) 610 may also be configured to detect a difference between a first payload associated with the first cache miss and a second payload associated with the second cache miss as illustrated in FIG. 5. The processor(s) 610 may also be configured to, for the difference not being detected, increase the TTL of the query by a first amount of time as illustrated in FIG. 5. The processor(s) 610 may also be configured to, for the difference being detected, reduce the TTL of the query by a second amount of time as illustrated in FIG. 5. The processor(s) 610 may also be configured to, for the TTL being reduced to equal to or less than a TTL threshold, preventing a query result associated with the query from being stored in the cache as illustrated in FIG. 5.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example embodiments, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example embodiments may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software embodiments that involve instructions that perform the operations of the desired embodiment.

Various general-purpose systems may be used with programs and modules in accordance with the examples herein, or it may prove convenient to construct a more specialized apparatus to perform desired method steps. In addition, the example embodiments are not described with reference to any particular programming language. It will be appreciated that a variety of programming languages may be used to implement the teachings of the example embodiments as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example embodiments may be implemented using circuits and logic devices (hardware), while other aspects may be implemented using instructions stored on a machine-readable medium (software), which if executed by a processor, would cause the processor to perform a method to carry out embodiments of the present application. Further, some example embodiments of the present application may be performed solely in hardware, whereas other example embodiments may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other embodiments of the present application will be apparent to those skilled in the art from consideration of the specification and practice of the teachings of the present application. Various aspects and/or components of the described example embodiments may be used singly or in any combination. It is intended that the specification and example embodiments be considered as examples only, with the true scope and spirit of the present application being indicated by the following claims.

1. A method for managing time-to-live (TTL) associated with a query stored in a cache, the method comprising a processor performing the following operations in an iterative manner:
detecting a first cache miss and a second cache miss associated with the query, wherein the first cache miss precedes the second cache miss in time;
detecting a difference between a first payload associated with the first cache miss and a second payload associated with the second cache miss, wherein the first payload and the second payload are retrieved for processing from a database in communication with the cache after the second cache miss has been detected; and
for the difference not being detected, increasing the TTL of the query by a predetermined percentage of the TTL.

2. The method of claim 1, wherein the cache is a wire protocol-compatible database cache configured to communicate between an application that receives a user input including the query and the database.

3. The method of claim 1, further comprising:
for the difference being detected, removing a query result associated with the query from the cache and placing the query in a penalty state in which the TTL is not further increased or reduced.

4. The method of claim 3, further comprising:
for the query in the penalty state, once a condition is satisfied:
caching a current query result associated with the query into the cache and removing the query from the penalty state.

5. The method of claim 4, wherein the condition comprises:
while the query is in the penalty state, incrementing a counter each time the query is received from an application; and
comparing the counter against a query threshold indicative of a threshold number of queries received from the application while the TTL is in the penalty state.

6. The method of claim 5, further comprising:
determining whether the counter is equal to the query threshold; and
for the counter determined to be equal to the query threshold, removing the query from the penalty state.

7. A method for adjusting time-to-live (TTL) associated with a query stored in a cache, the method comprising a processor performing the following operations in an iteratively manner:
detecting a first cache miss and a second cache miss associated with the query, wherein the first cache miss precedes the second cache miss in time;
detecting a difference between a first payload associated with the first cache miss and a second payload associated with the second cache miss, wherein the first payload and the second payload are retrieved for processing from a database in communication with the cache after the second cache miss has been detected;
for the difference not being detected, increasing the TTL of the query by a predetermined percentage of the TTL; and
for the difference being detected;
reducing the TTL of the query by a second predetermined percentage of the TTL; and
for the TTL of the query being reduced to equal to or less than a minimum TTL threshold, preventing a query result associated with the query from being stored in the cache.

8. The method of claim 7, wherein the first predetermined percentage of the TTL is 20% of the TTL.

9. The method of claim 8, wherein the second predetermined percentage of the TTL is 40% of the TTL.

10. (canceled)

11. The method of claim 10, wherein the minimum TTL threshold is 50 milliseconds.

12. A system for managing time-to-live (TTL) associated with a query, the system comprising:
a cache for storing the query;
a processor in communication with the cache and iteratively performs:
detect a first cache miss and a second cache miss associated with the query, wherein the first cache miss precedes the second cache miss in time;
detect a difference between a first payload associated with the first cache miss and a second payload associated with the second cache miss, wherein the first payload and the second payload are retrieved for processing from a database in communication with the cache after the second cache miss has been detected; and
for the difference not being detected, increasing the TTL of the query by a predetermined percentage of the TTL.

13. The system of claim 12, wherein the cache is a wire protocol-compatible database cache configured to communicate between an application that receives a user input including the query and the database.

14. The system of claim 12, wherein the processor is further configured to:
for the difference being detected, remove a query result associated with the query from the cache and place the query in a penalty state in which the TTL is not further increased or reduced.

15. The system of claim 14, wherein the processor is further configured to:
for the query in the penalty state, once a condition is satisfied:
cache a current query result associated with the query into the cache and remove the query from the penalty state.

16. The system of claim 15, wherein the condition comprises:
while the query is in the penalty state, incrementing a counter each time the query is received from an application; and
comparing the counter against a query threshold indicative of a threshold number of queries received from the application while the TTL is in the penalty state.

17. The system of claim 16, wherein the processor is further configured to:
determine whether the counter is equal to the query threshold; and
for the counter determined to be equal to the query threshold, remove the query from the penalty state.

18. A non-transitory computer readable medium, storing instructions for managing time-to-live (TTL) associated with a query stored in a cache, the instructions comprising:
performing the following operations in an iterative manner:
detecting a first cache miss and a second cache miss associated with the query, wherein the first cache miss precedes the second cache miss in time;
detecting a difference between a first payload associated with the first cache miss and a second payload associated with the second cache miss, wherein the first payload and the second payload are retrieved for processing from a database in communication with the cache after the second cache miss has been detected;
for the difference not being detected, increasing the TTL of the query by a predetermined percentage of the TTL; and
for the difference being detected, removing a query result associated with the query from the cache and placing the query in a penalty state in which the TTL is not further increased or reduced.

19. The non-transitory computer readable medium of claim 18, further comprising:
for the query in the penalty state, once a condition is satisfied:
caching a current query result associated with the query into the cache and removing the query from the penalty state.

20. The non-transitory computer readable medium of claim 19, wherein the condition comprises:
while the query is in the penalty state, incrementing a counter each time the query is received from an application;
comparing the counter against a query threshold indicative of a threshold number of queries received from the application while the TTL is in the penalty state;
determining whether the counter is equal to the query threshold; and
for the counter determined to be equal to the query threshold, removing the query from the penalty state.
